(19) United States
(12) Patent Application Publication
(10) Pub. No.: US 2004/0117741 A1
(43) Pub. Date: Jun. 17, 2004

(54) System and method for managing document processing in a networked environment

(75) Inventors: Jeremy A. Robkin, Duvall, WA (US); Jeffery L. LaPlante, Everett, WA (US); Stevan J. Challenger, Camano Island, WA (US); Brett R. Bennett, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Expeditors International of Washington Inc.

(21) Appl. No.: 10/321,866

(22) Filed: Dec. 17, 2002

(51) Int. Cl. G06F 17/21

(52) U.S. Cl. 715/531

(57) ABSTRACT

A system and method for processing shipment documentation is provided. A referral processing system obtains incoming shipment documentation and identifies one or more discrepancies associated with the shipment documentation/information. The referral processing system generates a document referral identifying the discrepancies and transmits a notification of the referral to a component of the document processing system. One or more components of the document processing system then transmits a referral solution to the referral processing system in an attempt to resolve the document referral. As document referrals are generated and document referral solutions are received, the referral processing system maintains local and master databases of information and provides information related to the current status of individual document referrals and a cumulative status of all the transactions related to particular customers via a user interface.

### FIELD OF THE INVENTION

In general, the present invention relates to computer networks and software, and in particular, to a system and method for facilitating transaction documentation processing in a networked environment.

### BACKGROUND OF THE INVENTION

Generally described, transactions, such as international commerce transactions, typically require a number of documents to facilitate the movement of goods related to the transaction. In an example international transaction, international shipments of goods typically require a number of documents/information to allow the goods to be filed with and released by customs officials of an importing country. To the extent any required document is missing, incomplete or incorrect, an international shipment of goods may be prevented from being imported by customs officials until the documentation/information is complete and correct. If the importation of goods is delayed sufficiently, an importer often incurs penalties for storage of the goods at the port of entry. Further, the importer can suffer additional financial losses associated with the unavailability of the goods for sale/manufacture and/or the loss of perishable goods.

In one illustrative embodiment, an importer may initiate shipments of goods from a number of shippers that enter the importing country through a number of ports of entry. From a financial aspect, as the number and frequency of international shipments increase, the financial risk associated with penalties, additional storage costs and/or delayed shipments can also increase significantly. Accordingly, importers are generally motivated to monitor their shipments to ensure that any problems associated with individual shipments, such as inadequate or incorrect documentation/information, are resolved as quickly as possible. Additionally, importers are motivated to monitor shipper performance/compliance to identify problematic shippers.

From a logistical aspect, in a high volume shipment environment encompassing a number of ports of entry, centralized monitoring of documentation is made more difficult by the need for having at least some local or regional presence to physically manage incoming shipment documentation. For example, documentation discrepancies can often only be identified via a physical inspection of the shipment documentation accompanying the incoming goods. Additionally, to the extent an importer utilizes a third-party document management service to resolve any documentation problems, the problems associated with centralized documentation monitoring and problem resolution may be increased if the third-party document management service is not integrated with the importer. This problem is further amplified if the importer utilizes multiple third-party document management services that may have inconsistent data formats or communication architecture.

Thus, there is a need for a system and method for providing centralized shipment documentation monitoring and document problem resolution.

### SUMMARY OF THE INVENTION

A system and method for processing shipment documentation is provided. A referral processing system obtains incoming shipment documentation and identifies one or more discrepancies associated with the shipment documentation. The referral processing system generates a document referral identifying the discrepancies and transmits a notification of the referral to a component of the document processing system. One or more components of the document processing system then transmits a referral solution to the referral processing system in an attempt to resolve the document referral. As document referrals are generated and document referral solutions are received, the referral processing system maintains local and master databases of information and provides information related to the current status of individual document referrals and a cumulative status of all the transactions related to particular customers via a user interface.

In accordance with an aspect of the present invention, a method for processing document discrepancies in documents associated with a transaction is provided. A referral processing system obtains an identification of discrepancies associated with at least one document. The referral processing system generates a document referral corresponding to the at least one document. The document referral includes data indicative of the identification of the document discrepancies. The referral processing system automatically transmits a notification of the document referral to an identified recipient. The notification includes data indicative of the identification of the document discrepancies. The referral processing system also generates a user interface including data indicative of a status the document referral.

In accordance with another aspect of the present invention, a system for processing document discrepancies in documents associated with a transaction is provided. The system includes at least one reception component corresponding to the documents associated with the transaction. The system also includes a document referral processing system for obtaining an identification of discrepancies associated with the document and for generating a document referral corresponding to at least one document. The document referral includes data indicative of the identification of the document discrepancies. The document referral processing system transmits a notification of the document referral to the at least one reception component.

In accordance with a further aspect of the present invention, a method for processing document discrepancy data for documents corresponding to transactions is provided. The method may be implemented in a system having a graphical user interface including a display and an interface device. In accordance with the method, a referral processing device obtains a set of document referrals corresponding to an identification of document discrepancy data in at least one document. The referral processing device displays a user interface including a listing of at least one of the set of document referrals. The listing includes a status for the document referral. The referral processing device obtains an input from the interface device corresponding to initiate an action on a selected document referral. The referral processing device processes the input to initiate the action on the selected document referral.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a representative portion of the Internet;

FIG. 2 is a block diagram of a document processing system including a number of importer computing devices, a number of shipper computing devices, a number of local document referral processing computing devices, and a master referral processing computing device formed in accordance with the present invention;

FIG. 3 is a block diagram depicting an illustrative architecture for an importer computing device and a shipper computing device in accordance with the present invention;

FIG. 4 is a block diagram depicting an illustrative architecture for a local document referral processing computing device and a master document referral processing computing device in accordance with the present invention;

FIG. 5 is a block diagram of the document processing system of FIG. 2 illustrating the processing of incoming shipment documentation and the generation and transmittal of document referrals in accordance with the present invention;

FIG. 6 is a block diagram of the document processing system of FIG. 2 illustrating the processing of document referral solutions and the updating of document referral information in accordance with the present invention;

FIGS. 7A, 7B and 7C are flow diagrams illustrative of a shipment documentation processing routine implemented by a referral processing computing device in accordance with the present invention;

FIG. 8 is a block diagram illustrative of a screen display for facilitating the generation of a document referral in a referral processing computing device in accordance with the present invention;

FIG. 9 is a block diagram illustrative of a document referral notification data format transmitted by a referral processing computing device in accordance with the present invention; and

FIG. 10 is a block diagram illustrative of a screen display for facilitating the management of document referrals and referral solutions by a referral processing computing device in accordance with the present invention.

### DETAILED DESCRIPTION OF THE PREFERRED EMBODIMENT

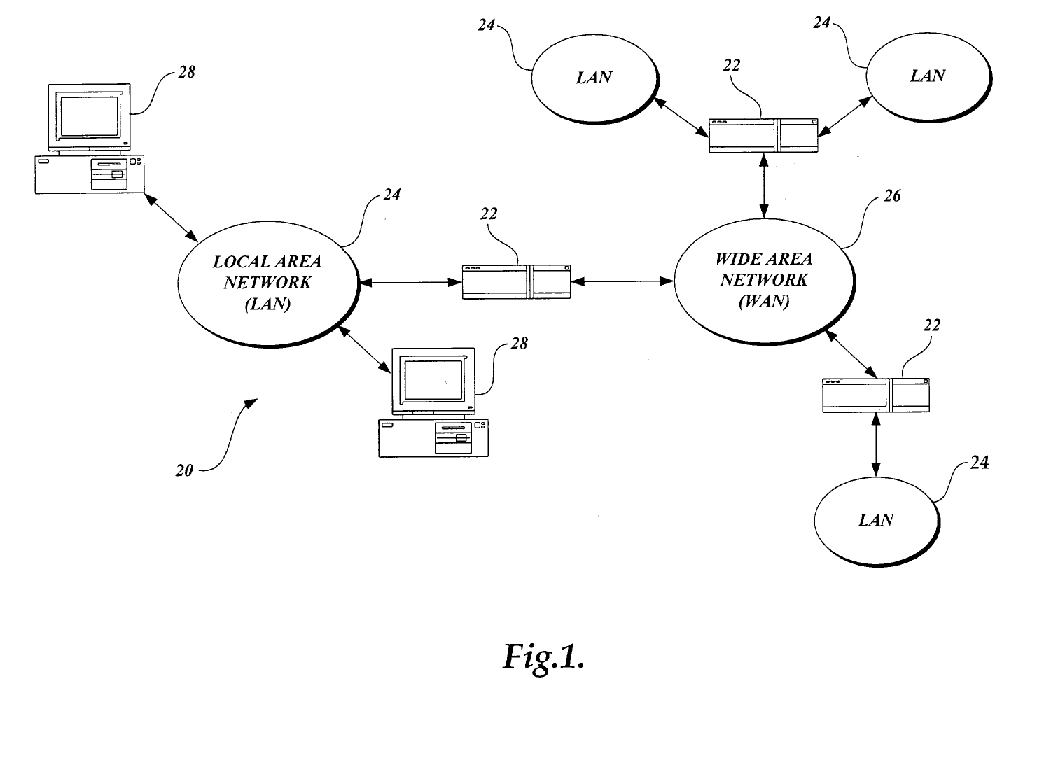

As described above, aspects of the present invention are embodied in a World Wide Web (“WWW”) or (“Web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, where a plurality of local area networks (“LANs”) 24 and a wide area network (“WAN”) 26 are interconnected by routers 22. The routers 22 are special purpose computers used to interface one LAN or WAN to another. Communication links within the LANs may be twisted wire pair, coaxial cable, or optical fiber, while communication links between networks may utilize 56 Kbps analog telephone lines, 1 Mbps digital T-1 lines, 45 Mbps T-3 lines or other communications links known to those skilled in the art.

Furthermore, computers 28 and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. Other interactive hypertext environments may include proprietary environments such as those provided in America Online or other online service providers, as well as the “wireless Web” provided by various wireless networking providers, especially those in the cellular phone industry. It will be appreciated that the present invention could apply in any such interactive hypertext environments, however, for purposes of discussion, the Web is used as an exemplary interactive hypertext environment with regard to the present invention.

A Web site is a server/computer connected to the Internet that has massive storage capabilities for storing hypertext documents and that runs administrative software for handling requests for those stored hypertext documents. Imbedded within a hypertext document are a number of hyperlinks, i.e., highlighted portions of text which link the document to another hypertext document possibly stored at a Web site elsewhere on the Internet. Each hyperlink is assigned a Uniform Resource Locator (“URL”) that provides the exact location of the linked document on a server connected to the Internet and describes the document. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a graphical user interface to the WWW. Upon request from the remote access user via the web browser, the web browser locates and retrieves the desired hypertext document from the appropriate web server using the URL for the document and the HTTP protocol. HTTP is a higher-level protocol than TCP/IP and is designed specifically for the requirements of the WWW. HTTP runs on top of TCP/IP to transfer hypertext documents between server and client computers. The WWW browser may also retrieve programs from the web server, such as JAVA applets, for execution on the client computer.

The present application is directed toward a system and method for facilitating the processing of documentation utilized to complete transactions. More specifically, the present invention is directed toward a system and method for the identification and notification of shipping documentation problems and for the resolution of the documentation problems in a networked environment. Although the present invention will be described in regards to an implementation with an illustrative document processing system, one skilled in the relevant art will appreciate that the disclosed document processing system and the disclosed embodiments are illustrative in nature and should not be construed as limiting.

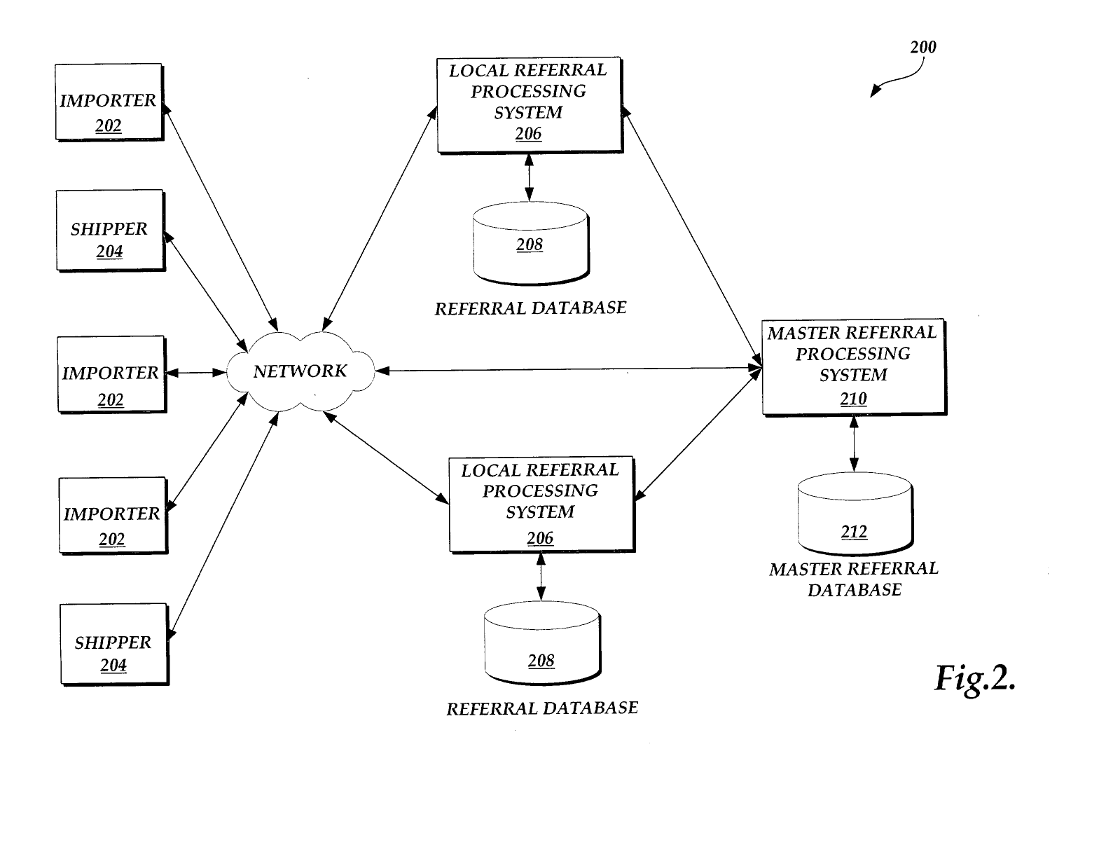

Referring now to FIG. 2, an interactive document processing system 200 for facilitating transactions between a number of parties involved in a product transaction will be described. In an illustrative embodiment of the present invention, the document processing system 200 can be a private, subscriber-based system allowing a number of parties to interact via a common communication network, such as the, Internet 20. Alternatively, the document processing system 200 can be a public system allowing access to any number of parties via the communication network. Still further, the document processing system 200 can also incorporate a combination of private and public communication networks.

As illustrated in FIG. 2, the document processing system 200 includes a number of importer computing devices 202 associated with one or more importers utilizing the document processing system. Although a limited number of importer computing devices 202 are shown in FIG. 2, the document processing system 200 can include any number of importer computing devices 202. The document processing system 200 also includes a number of shipper computing devices 204. In an illustrative embodiment of the present invention, each shipper computing device 204 corresponds to at least one importer computing device 202. Additionally, a shipper computing device 204 can correspond to multiple importer computing devices 202. Likewise, an importer computing device 202 can be associated with multiple shipper computing devices 204. One skilled in the relevant art will appreciate that a number of importer computing device 202 and shipper computing device 204 relationships may be utilized in conjunction with the present invention. Further, the importer computing devices 202 and the shipper computing devices 204 can correspond to any number of computing devices, such as personal computers, hand-held computers, server computers, personal digital assistants, mobile computing devices, mobile telephones, and any combination thereof.

The document processing system 200 also includes a number of referral processing systems 200 for identifying shipping document discrepancies and resolving the identified discrepancies. In an illustrative embodiment of the present invention, the document processing system 200 includes a number of local referral processing systems 206 that correspond to a particular port of entry or a particular region encompassing many ports of entry. Each local referral processing system 206 can include a referral database 208 for storing document referral processing data. In one embodiment, each local referral processing system 206 accesses a local referral database 208. However, one or more local document referral processing systems 206 may share access to a referral database 208.

Each local referral processing system 206 is in communication with a master referral processing system 210. In an illustrative embodiment of the present invention, the master referral processing system 210 includes a master referral database 212 that serves as a centralized data warehouse for managing incoming documentation data from each local referral processing systems 206 and for distributing the processed data to components within the document processing system 200, such as the importer computing devices 202 and/or the shipper computing devices 204. Although the master referral processing system 210 is illustrated as a separate component of the document processing system 200, one skilled in the art will appreciate that a local referral processing system 206 may also provide the functionality associated with the master processing system 210. Further, one skilled in the relevant art will appreciate that additional referral processing systems may be incorporated into the document processing system 200 to provide for intermediate data processing. For example, each local referral processing system 206 may communicate directly with a regional referral processing system (not shown), which in turn communicates with the master referral processing system 210.

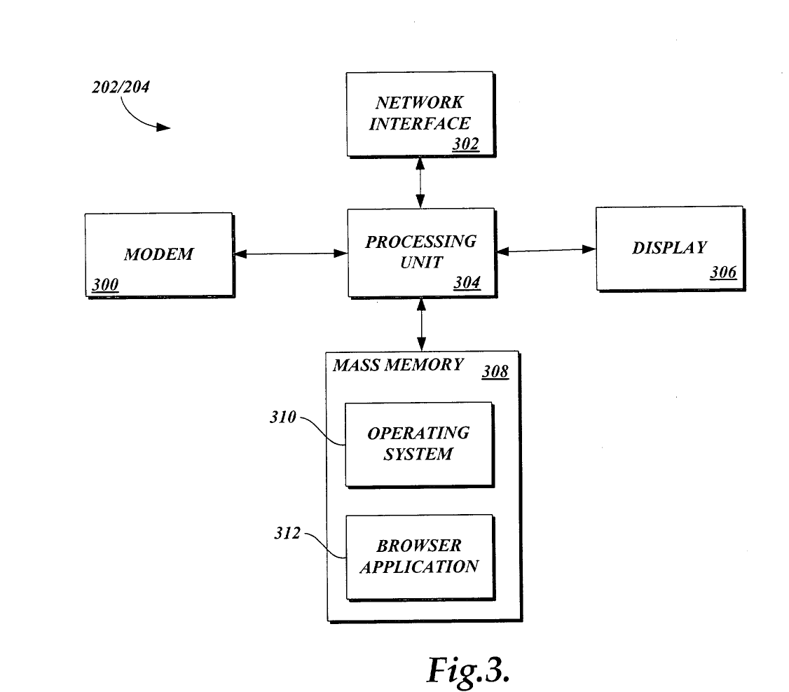

FIG. 3 depicts several of the key components of an importer computing device 202 and/or a shipper computing device 204 (FIG. 2). Those of ordinary skill in the art will appreciate that the computing devices can include many more components than those shown in FIG. 3. However, it is not necessary that all of these generally conventional components be shown in order to disclose an illustrative embodiment for practicing the present invention.

As shown in FIG. 3, each computing device may include a modem 300 for connecting to an Internet service provider through a Point-to-Point Protocol (“PPP”) connection or a Serial Line Internet Protocol (“SLIP”) connection as known to those skilled in the art. The modem 300 may utilize a telephone link, cable link, wireless link, Digital Subscriber Line or other types of communication links known in the art. The computing devices may also include a network interface 302 for connecting directly to a LAN or a WAN, or for connecting remotely to a LAN or WAN. Those of ordinary skill in the art will appreciate that the network interface 302 includes the necessary circuitry for such a connection, and is also constructed for use with various communication protocols, such as the TCP/IP protocol, the Internet Inter-ORB Protocol (“IIOP”), and the like. The network interface 302 may utilize the communication protocol of the particular network configuration of the LAN or WAN it is connecting to, and a particular type of coupling medium.

The computing devices also include a processing unit 304, a display 306, and a memory 308. The memory 308 generally comprises a random access memory (“RAM”), a read-only memory (“ROM”), and a permanent mass storage device, such as a hard disk drive, tape driver, optical drive, floppy disk drive, CD-ROM, DVD-ROM, or removable storage drive. The memory 308 stores an operating system 310 for controlling the operation of the importer computing device 202. The memory 308 also includes an access application communication application for accessing the document processing system 200 via the communication network. Examples of an access application can include a WWW browser 312, such as Netscape's NAVIGATORS or Microsoft's INTERNET EXPLORER® browsers. The access application can also include an electronic mail component for obtaining and transmitting electronic communications with other components in the document processing system 200. One skilled in the relevant art will appreciate that these components may be stored on a computer-readable medium and loaded into memory 308 of the importer computing device 202 using a drive mechanism associated with the computer-readable medium, such as a floppy, CD-ROM, DVD-ROM drive, or network interface 302. The memory 308, display 306, modem 300 and network interface 302 are all connected to the processor 304 via a bus. Other peripherals may also be connected to the processor in a similar manner.

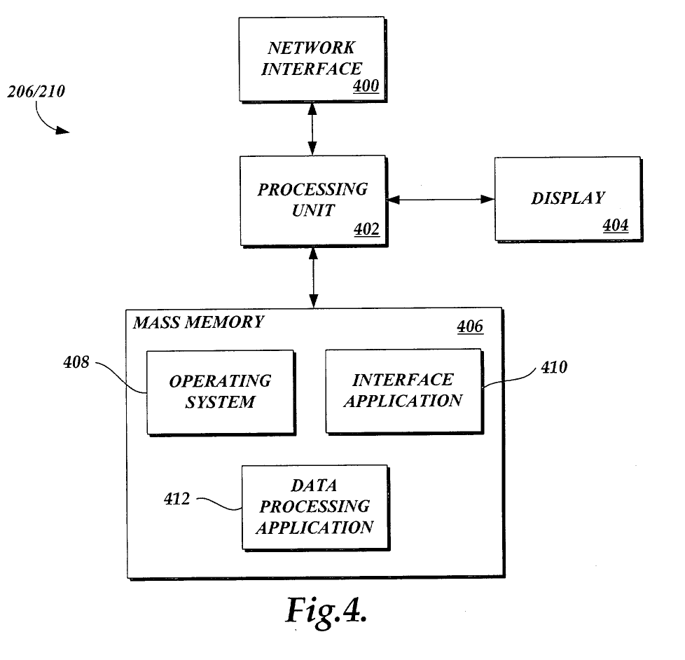

FIG. 4 is a block diagram depicting an illustrative architecture of a referral processing system (FIG. 2) in accordance with the present invention. In an illustrative embodiment of the present invention, the local referral processing computing device 206 and the master referral processing computing device 210 may share a common architecture and application functionality. However, one skilled in the relevant art will appreciate that local referral processing systems 206 and the master referral processing systems 210 may have different hardware aspects and/or different application functionality depending on the data flow expectations for each system and the assigned function for each system.

As shown in FIG. 4, the referral processing system is connected to the communication network via a network interface 400. Those of ordinary skill in the art will appreciate that the network interface 400 includes the necessary circuitry for connecting the referral processing server 204 to the Internet 20, and is constructed for use with the TCP/IP protocol, or other protocols, such as IIOP. The referral processing system also includes a processing unit 402, a display 404 and a mass memory 406, all connected via a communication bus, or other communication device. The mass memory 406 generally comprises a RAM, ROM, and a permanent mass storage device, such as a hard disk drive, tape drive, optical drive, floppy disk drive, or combination thereof. The mass memory 406 stores an operating system 408 for controlling the operation of the referral processing system. It will be appreciated that this component may comprise a general-purpose server operating system as is known to those skilled in the art, such as UNIX, LINUX™, or Microsoft WINDOWS NT®.

The mass memory 406 also stores program code and data for interfacing with one or more components of the document processing system 200 and for identifying and resolving documentation discrepancies. More specifically, the mass memory 406 stores a component interface application 410 in accordance with the present invention for communicating with importer computing devices 202, shipper computing devices 204 and other referral processing systems. The mass memory 406 further stores a data processing 412 for generating and transmitting document discrepancy referrals and for resolving previously generated document referrals. The data processing application 412 may also be utilized to manage document referral information including the maintenance of document referral status and the generation of reports corresponding to various queried fields. The operation of the data processing application 412 for each referral processing system component will be described in greater detail below. One skilled in the relevant art will appreciate that the various components may be stored on a computer-readable medium and loaded into the memory 406 using a drive mechanism associated with the computer-readable medium, such as a floppy, CD-ROM, DVD-ROM drive, or network interface 400.

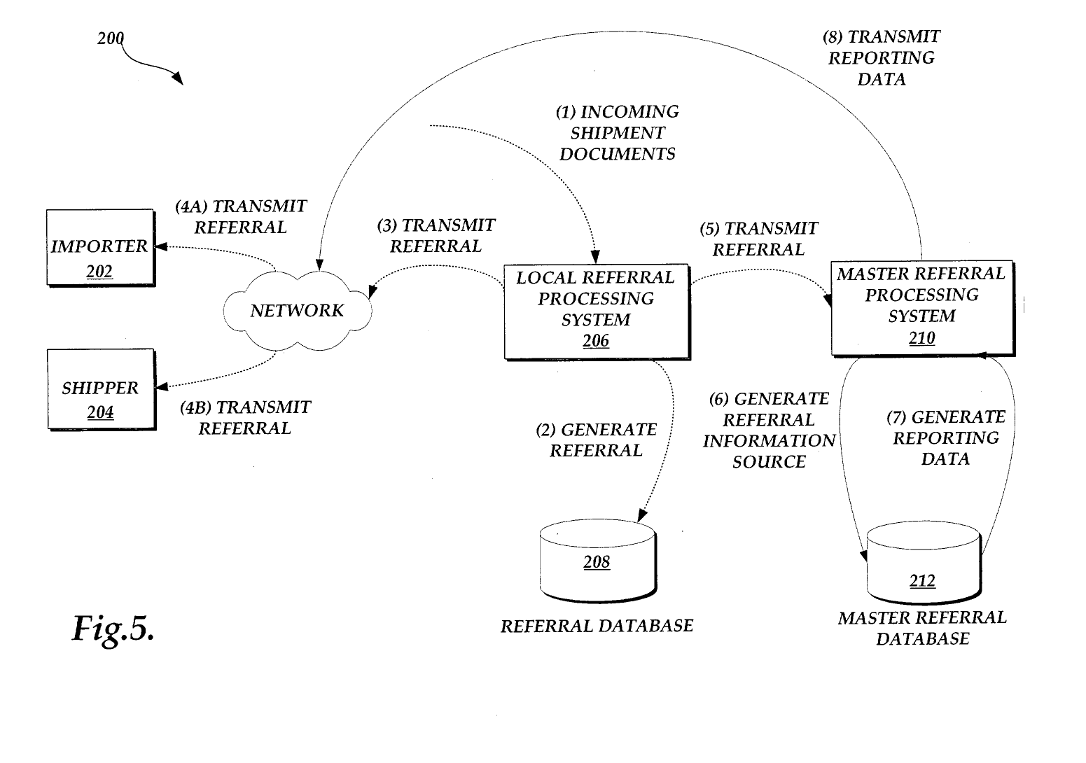

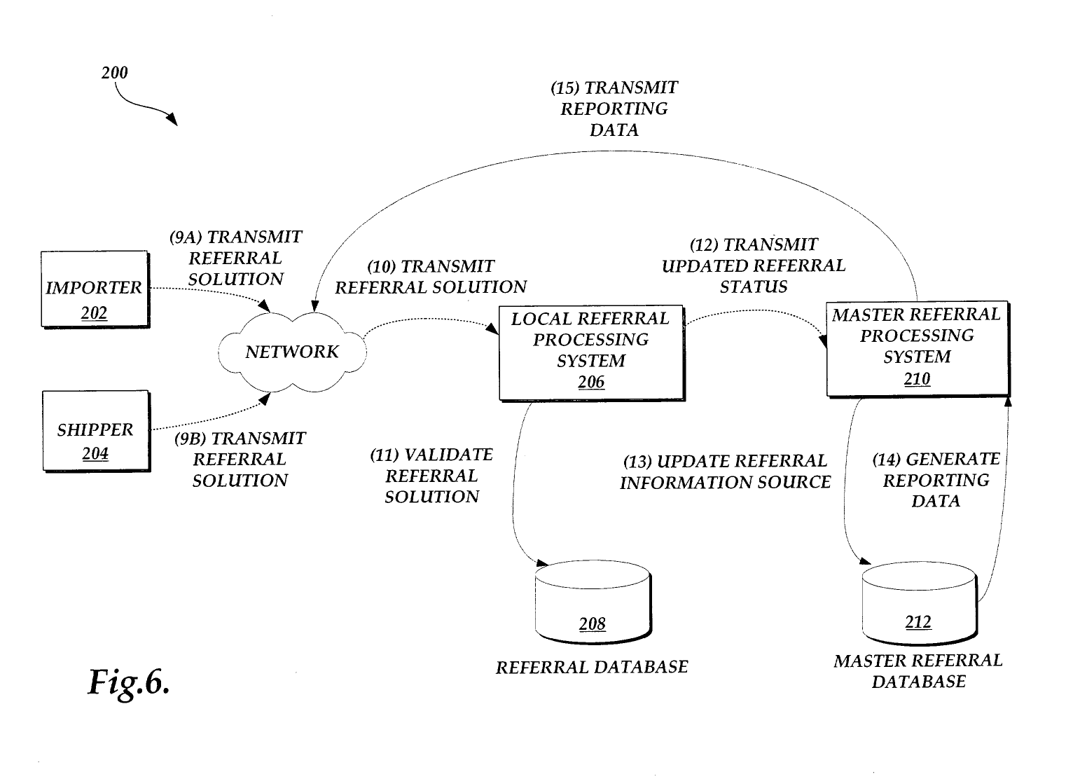

Referring now to FIGS. 5 and 6, a general overview of the document processing system 200 and the interaction between the various components of the document processing system will be described. FIG. 5 is a block diagram of the document processing system 200 of FIG. 2 illustrating the processing of incoming shipment documentation and the generation and transmittal of document referrals in accordance with the present invention. As illustrated in FIG. 5, in an embodiment of the present invention, a local referral processing system 206 receives incoming shipment documentation. In an illustrative embodiment of the present invention, the incoming shipment documents may be physically transferred to an agent of the local referral processing system 206 as the shipment is received at a port of entry. Alternatively, the incoming shipment documents may be electronically generated and received by the local referral processing system 206.

The local referral processing system 206 reviews the incoming documents and generates a referral for any discrepancies identified with the incoming shipment documents. In an illustrative embodiment of the present invention, the generation of a referral may correspond to a physical inspection of incoming shipment documents to identify any discrepancies associated with existing documents, or the identification of an omitted document. Additionally, one or more processing applications may be utilized to automatically detect incorrect or incomplete documents. The generation of a document discrepancy referral will be described in greater detail below.

Upon the generation of a document referral, the local referral processing system 206 transmits referral notifications to one or more corresponding components. As illustrated in FIG. 5, the local referral processing system 206 can transmit a referral to an importer 202 or a shipper 204 via the communication network. In an illustrative embodiment of the present invention, the referral may be in the form of an electronic mail communication that provides information related to the document referral, and a mechanism for which to achieve a solution for that referral. Further, although the referral is illustrated as being transmitted to both an importer 202 and shipper 204, the local referral processing system 206 may specify which component to receive the referral and/or may ship different notifications to specific components. In addition to transmitting referral notifications, the local referral processing system 206 may also transmit referral information to a master referral processing system 210. The master referral processing system 210 can then generate a generalized referral information source, that collects and sorts referral information for a particular client, a particular port of entry, or any other organizational criteria. Further, the master referral processing system 210 may make that cumulative referral information available to a component of the document processing system 200 via an interface, such as a Web page.

With reference now to FIG. 6, after the components have received the document referral, one of the components, such as the importer 202 or the shipper 204, can transmit a referral solution to a local referral processing system 206 via the communication network. Upon receiving the referral solution, local processing system 206 can match the transmitted solution to a particular open referral and then determine whether the referral solution resolves the documentation discrepancy identified in the referral solution. In the event that the document referral is not completed, the local referral processing system 206 can repeat the actions illustrated in FIG. 5. Accordingly, the process can continue to be repeated until the referral is closed.

With each iteration, the local referral processing system 206 transmits the updated referral status to the master referral processing system 210. Accordingly, the master referral processing system 210 can update the master referral information source 212. Based on the collection of all of the document referral and referral solution data, the master referral processing system 210 can then generate reports for a particular importer 202 that tracks a current status for each document referral and can identify the performance aspects for every shipper 204 utilized by the particular importer. The reporting data may be transmitted via the communication network, or alternatively, via a direct communication link. Further, the master referall processing system 210 may also maintain the reporting information in a reporting database. Accordingly, the referral processing systems 206 and 210 are utilized to resolve individualized document discrepancies in an efficient manner, and further to collect referral data for the analysis of possible problematic areas.

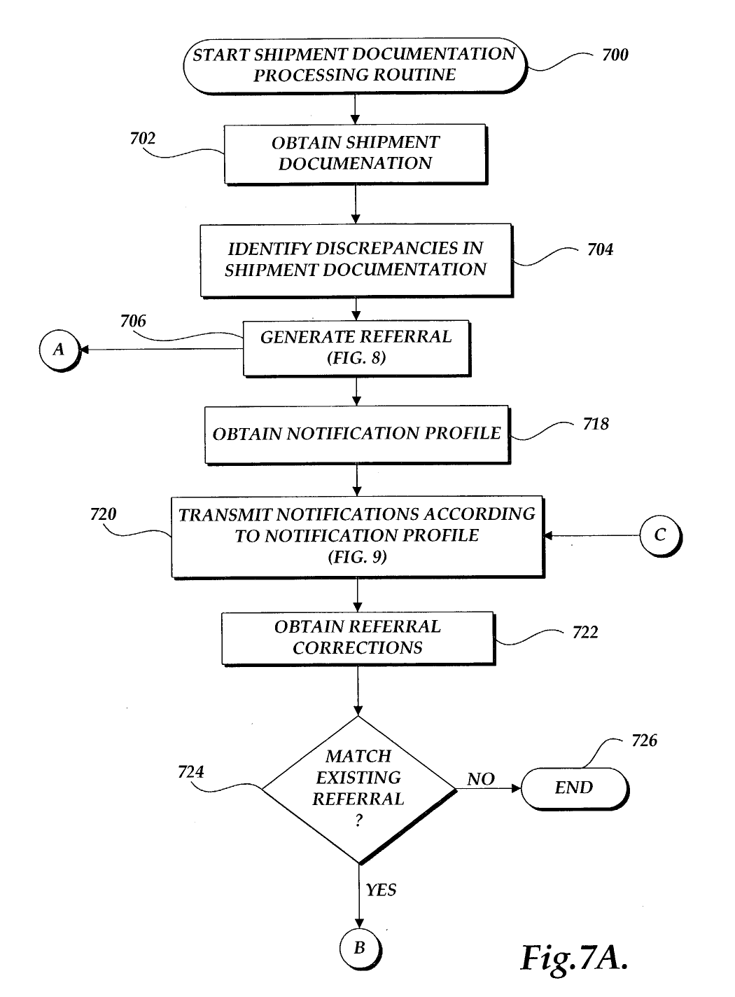

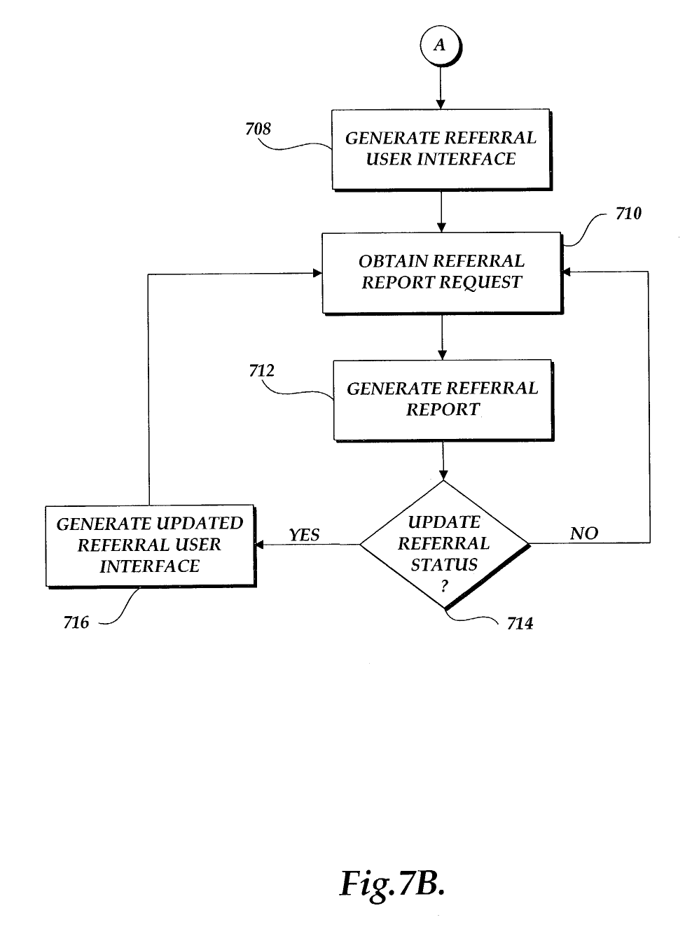

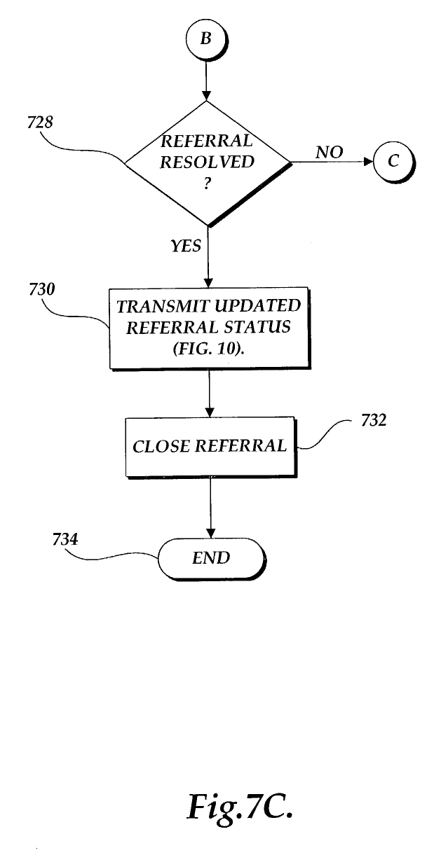

With reference now to FIGS. 7A, 7B and 7C, a shipment documentation processing routine 700 implemented by one or more of the referral processing systems will be described. One skilled in the relevant art will appreciate the routine 700 may be implemented by a single referral processing system or distributed to a number of referral processing systems. At block 702, a referral processing system 206 obtains shipment documentation. As described above, the shipment documentation is typically received by one of the local referral processing systems 206 corresponding to a particular port of entry. Further, the shipment documentation may be obtained either as a physical hardcopy or an electronic copy. At block 704, the referral processing system identifies discrepancies in shipment documentation. In an illustrative embodiment of the present invention, the identification discrepancies in the shipment documentation can require a physical review of the documentation to identify any incorrect or omitted documents. Additionally, the discrepancies may be provided to the referral processing system by a customs official or other transaction official. Further, in another illustrative embodiment, the data processing application 412 of the referral processing system may also utilize some type of a functionality or tool that will allow for the automatic identification of discrepancies in the shipment documentation. At block 706, the referral processing system generates a document referral corresponding to the identified discrepancy.

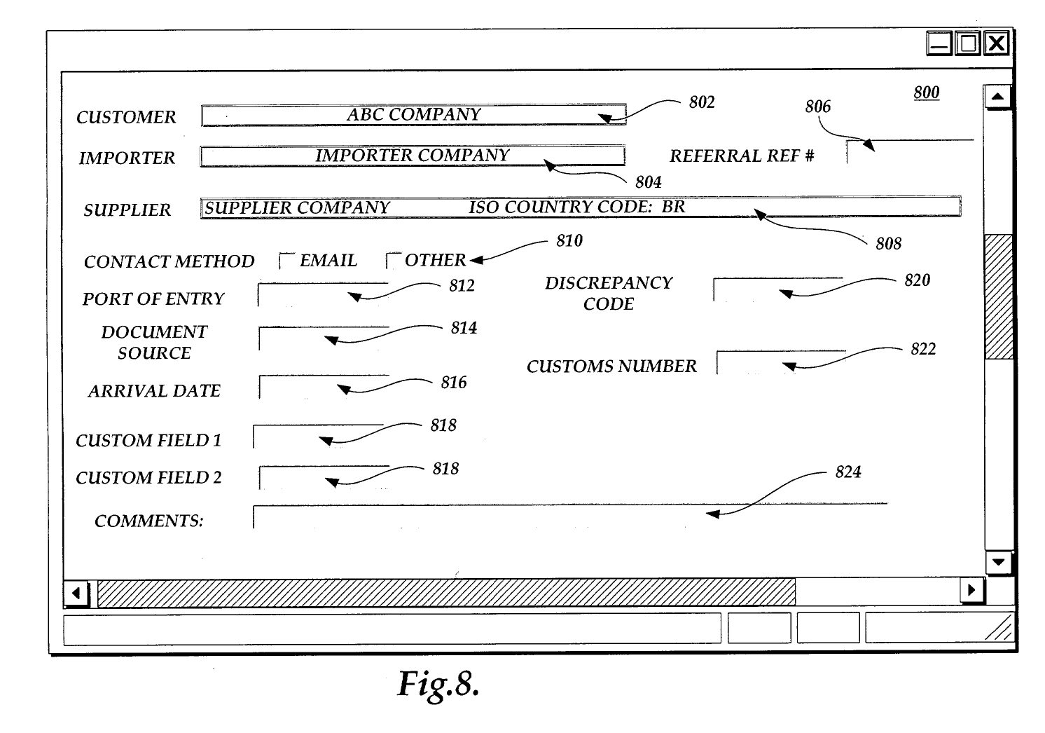

FIG. 8 is a block diagram illustrative of a screen display 800 for facilitating the generation of a document referral in a referral processing system in accordance with the present invention. The screen display 800 can include a number of fields corresponding to various parties associated with the shipment. For example, screen display 800 can include a customer field 802, an importer field 804, an internal reference number field 806, and a supplier company field 808. In an illustrative embodiment of the present invention, the population of the field with certain information may allow for the selection of a limited number of values for the other field. For example, once a customer name has been entered in the customer field 802, only the list of approved importers may be entered into importer field 804. Further, one or more fields may be automatically populated based on inputted criteria and/or values in other fields.

The screen display 800 can also include one or more fields identifying aspects of the particular transaction associated with the document discrepancy. For example, the screen display 800 can provide a contact preference field 810 for identifying how a document referral will be sent to the particular parties. The screen display 800 can also include fields for identifying particular aspects of the transaction itself such as a port of entry field 812, a document source field 814, and a goods arrival field 816. Further, the screen display 800 can also include a number of custom fields 818 specified by the customer and/or the importer for ease in identifying aspects of the transaction. The screen display 800 can also include a customs number field 822, that corresponds to information provided by a customs official or any other government agency.

The screen display 800 can also include a discrepancy code field 820 that identifies a particular discrepancy code characterizing the discrepancy found in documentation. In an illustrative embodiment of the present invention, the referral processing system can generate a list of system approved discrepancy codes. Further, the individual customer and/or importer can modify the list of approval codes, for identifying particular discrepancies associated with the transaction. The screen display 800 can further include a comments field 824 that allows the referral processing system to narratively describe a discrepancy associated with a particular discrepancy code. Accordingly, the discrepancy code may be a more generalized identification of the discrepancy that may be explained in further detail in the comments field 824.

Turning now to FIG. 7B, upon the generation of a referral by a referral processing system, the document process system 200 may also generate a user interface for displaying the referral information to an authorized component of the document processing system 200. In an illustrative embodiment of the present invention, a referral is generated by a local referral processing system 206 and the information is downloaded to the master referral processing system 210. Accordingly, the master referral processing system 210 can then provide the information to a cumulative collection of the referral processing systems. At block 708, the referral processing system generates a referral user interface. In an illustrative embodiment of the present invention, the referral user interface can include login and access functionality to limit which entities may view the referral information. The user interface can also provide query logic that allows for customization of the requested information. At block 710, the referral processing system obtains a referral report request from a user. At block 712 the referral processing system generates a referral report corresponding to the referral report request. The referral report may be presented graphically on a Web page and/or may be embodied as a document.

At decision block 714, a test is conducted to determine whether there is an updated referral status. In an illustrative embodiment of the present invention, each local referral processing system 206 periodically transmits update or referral information to the master referral processing system 210. If no referral status has been updated, the routine 700 returns to block 710 to obtain the next referral report request from an authorized user. Alternatively, if an update to the referral status has been received, at block 716, then the referral processing system generates an updated referral user interface and returns to block 710 to obtain the next referral report request. In an illustrative embodiment of the present invention, this branch of routine 700 will continue to provide access to the referral status to authorized users as referrals are generated and processed by the document processing system 200.

Returning now to FIG. 7A, in addition to the processing of a referral user interface (FIG. 7B), in an concurrent process, the referral processing system obtains a notification profile corresponding to the particular customer, importer, and supplier identified in the document referral. In an illustrative embodiment of the present invention, the notification profile specifies how document referrals are to be generated and transmitted and what information, if any, each participant in the transaction is to receive. At block 720, the referral processing system transmits notification according to the notification profile.

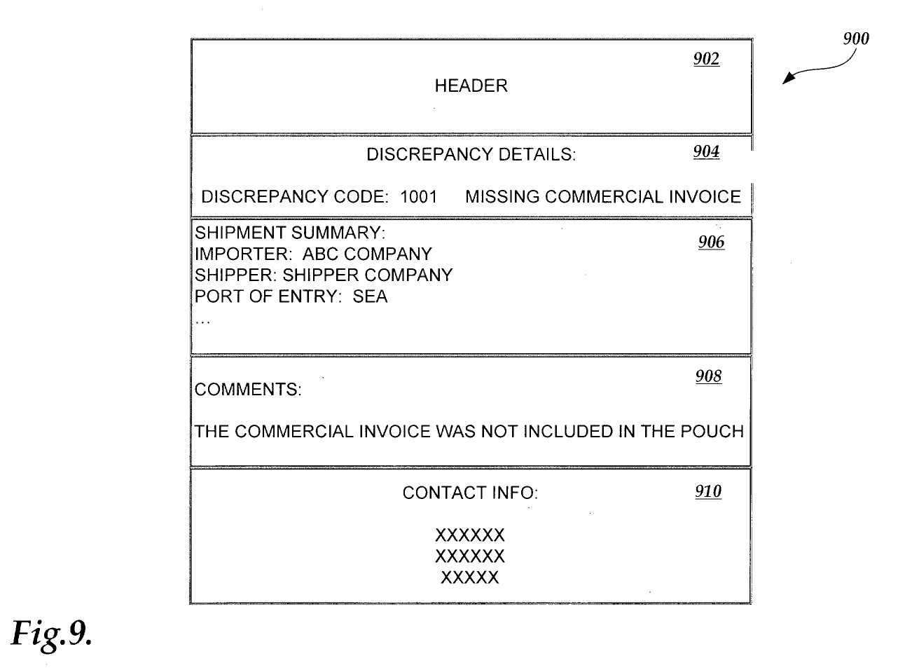

FIG. 9 is a block diagram illustrative of a referral notification, data format utilized by a referral processing system to transmit document referral to an authorized component within the document processing system 200. As illustrated in FIG. 9, the notification data format can include the header portion 902 that identifies the recipient of the referral notification and any other introductory information regarding the referral. The referral notification data format 900 can also include a discrepancy details portion 904 that can include the specified discrepancy code provided in the document referral. The referral notification data format 900 can also include a shipment summary 906 that identifies particular aspects of the transaction that will allow the recipient to determine which particular shipment included the discrepancy. The referral notification data format 900 can further include an additional comments field 908 that explains a discrepancy and/or the shipment summary. Further, the referral notification data format 900 can include a contact information format portion 910 that provides a manner of how to resolve the described discrepancy. In an illustrative embodiment of the present invention, full notifications may be sent to any number of components within the document processing system 200 notifying the particular component of a referral, and/or requesting particular solutions from the recipient.

At block 722, the referral processing system obtains a referral solution. In an illustrative embodiment of the present invention, the referral solution can be an electronic mail message including any omitted information, or the transmission of new documentation corresponding to an omitted document. At decision block 724, a test is conducted to determine whether the referral solution matches with an existing referral. If the referral solution does not match any existing referral, the routine 700 terminates at block 726.

Referring now to FIG. 7C, if the referral solution matches an existing referral, at decision block 728 a test is conducted to determine whether the referral is resolved. In an illustrative embodiment of the present invention, the referral solution may not include the complete information required, and/or may generate additional problems associated with a particular solution. If the referral is not resolved, the routine 700 returns to block 720 (FIG. 7A), where the referral processing system generates an additional notification and the routine 700 continues. Alternatively, if the referral solution resolves the particular referral, at block 730 the referral processing system transmits an updated referral status. At block 732, the referral processing system closes a referral, and the routine 700 terminates at block 734.

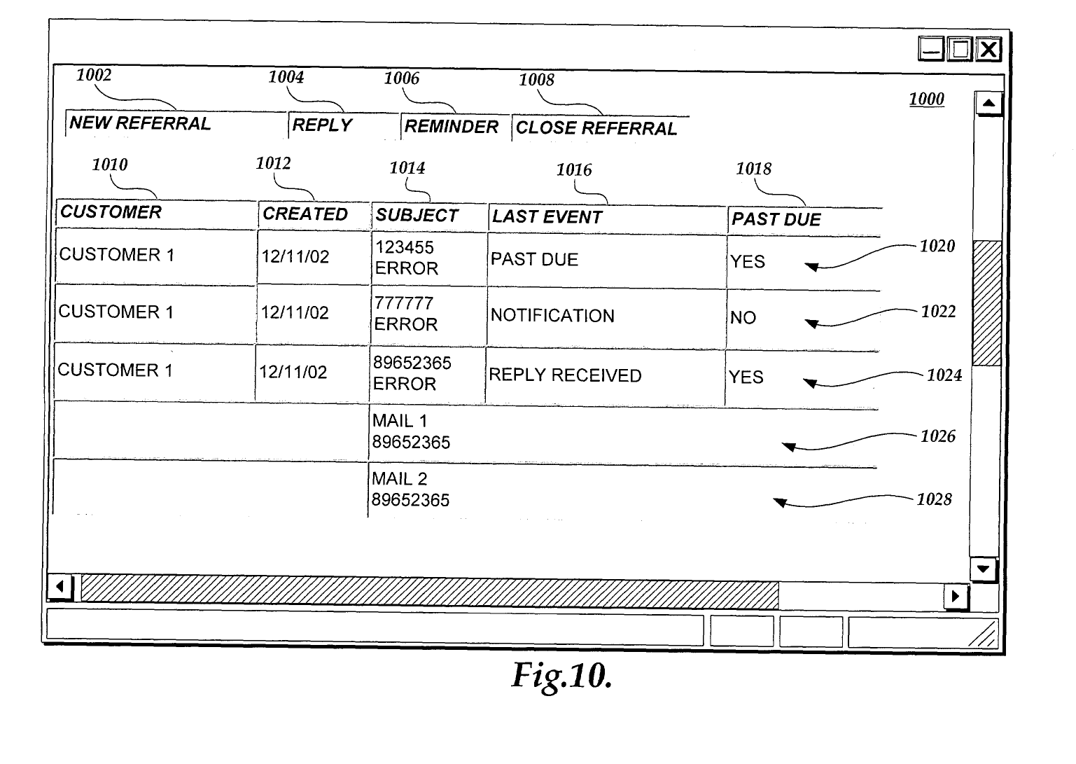

FIG. 10 is a block diagram illustrative of a screen display 1000 for facilitating the management of document referrals and referral solutions by a referral processing system. The screen display 1000 can be utilized as a referral processing system to coordinate each outstanding referral and for coordinating incoming referral solutions by a component of the document processing system. The screen display 1000 includes a number of components for implementing various functions associated with the processing of a referral. As illustrated in FIG. 10, the functional components can include a new referral component for generating a new referral illustrated in FIG. 8, a reply component for applying to a notification, a reminder component 1006 for generating the reminder to a notification previously sent, and closed referral function 1008 for closing out a referral upon the receipt of a referral solution satisfying the open referral. The screen display 1000 also includes a table formula that includes a column for identifying a customer 1010, a column for illustrating the date the referral was created 1012, a column for illustrating the subject matter of a particular referral 1014, a column for identifying the last action received by the referral 1016, and a column for indicating whether the referral was past due 1018. The referral processing system can then generate a number of records within that table identifying all pending document referrals and closed document referrals. For example, as illustrated in records 1020, 1022, the referrals can identify particular customers, the last event, and whether or not the particular referral is overdue. Further, as illustrated in record 1024, the screen display 1000 can include an identification of the referral generated by the document processing system, as well as the referral solutions received from a particular component of the document processing system 200. Accordingly, the screen display can be utilized by the document processing system, to identify pending document referrals and to associate received notifications for the purpose of closing out the referral or sending the reply or reminder to a particular user as described above with the functional components.

While illustrative embodiments of the invention have been illustrated and described, it will be appreciated that various changes can be made therein without departing from the spirit and scope of the invention.

The embodiments of the invention in which an exclusive property or privilege is claimed are defined as follows:

1. A method for processing document discrepancies in documents associated with a transaction, the method comprising:
obtaining an identification of discrepancies associated with at least one document;
generating a document referral corresponding to the at least one document, the document referral including data indicative of the identification of the document discrepancies;
automatically transmitting a notification of the document referral to an identified recipient, the notification including data indicative of the identification of the document discrepancies; and
generating a user interface including data indicative of a status of the document referral.

2. The method as recited in claim 1, wherein obtaining an identification of discrepancies associated with at least one document includes obtaining the at least one document and processing the document to identify any discrepancies.

3. The method as recited in claim 1, wherein obtaining an identification of discrepancies associated with at least one document includes obtaining a set of discrepancies from an external source.

4. The method as recited in claim 1, wherein automatically transmitting a notification of the document referral includes automatically transmitting a notification to a number of identified recipients.

5. The method as recited in claim 4, wherein automatically transmitting a notification of the document referral includes generating a unique notification for each recipient of the number of identified recipients and automatically transmitting the unique notification to each identified recipient.

6. The method as recited in claim 1 further comprising obtaining a referral solution from an identified recipient and updating the status of the document referral.

7. The method as recited in claim 6, wherein updating the status of the document referral includes updating the user interface.

8. The method as recited in claim 1, wherein each transaction is associated with a transaction facilitator, the method further comprising tracking document discrepancy statistics for each transaction facilitator.

9. The method as recited in claim 8 further comprising generating a user interface including data indicative of the document discrepancy statistics for each transaction facilitator.

10. A computer-readable medium having computer-executable instructions for performing the method recited in claim 1.

11. A computer system having a processor, a memory and an operating system, the computer system operable to perform the method recited in claim 1.

12. A system for processing document discrepancies in documents associated with a transaction, the system comprising:
at least one reception component corresponding to the documents associated with the transaction; and
a document referral processing system for obtaining an identification of discrepancies associated with the document and for generating a document referral corresponding to at least one document, the document referral including data indicative of the identification of the document discrepancies;
wherein the document referral processing system transmits a notification of the document referral to the at least one reception component.

13. The system as recited in claim 12, wherein the document referral processing system obtains the at least one document and processes the document to identify the document discrepancies.

14. The system as recited in claim 12, wherein the document referral processing system obtains the identification of discrepancies from an external source.

15. The system as recited in claim 12, wherein the system includes a plurality of reception components corresponding to the documents associated with the transaction, wherein the referral processing system transmits a notification of the document referral to each reception component.

16. The system as recited in claim 15, wherein the referral processing system generates unique notifications for each reception component of the plurality of reception components.

17. The system as recited in claim 12, wherein the referral processing system generates a user interface including data indicative of a status of each document referral.

18. The system as recited in claim 12, wherein the referral processing system obtains a referral solution from the at least one reception system and updates the status of a corresponding document referral.

19. The system as recited in claim 12, wherein the referral processing system is a local referral processing system corresponding to regional criteria, the system further comprising a master referral processing system for obtaining document referral data from the local referral processing system and generating a user interface corresponding to a status of document referrals.

20. The system as recited in claim 12, wherein each transaction is associated with a transaction facilitator and wherein the referral processing system tracks document discrepancy data for each transaction facilitator.

21. The system as recited in claim 20, wherein the referral processing system generates a user interface indicative of document discrepancy data for each transaction facilitator.

22. In a system having a graphical user interface including a display and an interface device, a method for processing document discrepancy data for documents corresponding to transactions, the method comprising:
obtaining a set of document referrals corresponding to an identification of document discrepancy data in at least one document;
displaying a user interface including a listing of at least one of the set of document referrals, the listing including a status for the document referral;
obtaining an input from the interface device corresponding to initiate an action on a selected document referral; and
processing the input to initiate the action on the selected document referral.

23. The method as recited in claim 22 further comprising:
obtaining a document solution corresponding to a selected document referral in the user interface;
associating the document solution with the selected document referral; and
updating the user interface to include the associated document solution.

24. The method as recited in claim 22, wherein the user interface includes a description of a document discrepancy associated with the document referral.

25. The method as recited in claim 22, wherein the input corresponds to generating a notification of a document referral.

26. The method as recited in claim 22, wherein the input corresponds to generating a reminder of a document referral.

27. The method as recited in claim 22, wherein the input corresponds to closing an open document referral.

28. A computer-readable medium having computer-executable instructions for performing the method recited in claim 22.
